(19) United States
(12) Patent Application Publication
(10) Pub. No.: US 2009/0271255 A1
(43) Pub. Date: Oct. 29, 2009

(54) COMMERCE AND ADVERTISEMENT BASED ON EXPLICIT CONSUMER'S VALUE COST PROPOSITION

(75) Inventors: Brian James Utter, Seattle, WA (US); Nishant V. Dani, Redmond, WA (US); Alexander G. Gounares, Kirkland, WA (US); Michael Conte, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/109,136

(22) Filed: Apr. 24, 2008

(51) Int. Cl. G06Q 30/00

(52) U.S. Cl. 705/14

(57) ABSTRACT

System(s) and method(s) are provided to drive commercial transactions and advertisement based on explicit consumer's value-cost propositions. Value-cost propositions express consumer's desires with respect to parameters related to a commercial transaction product price point, sensitivity to price and time, preferred shipping mechanism(s), contractor reputation, supply chain utilized by contractor, and so on. A component registers consumers to submit their value-cost propositions, and aggregates the information so conveyed to generate a market latent demand. The latter is conveyed to a set of advertisers, who respond to the latent demand by (i) adjusting their cost-profit propositions or (ii) countering the consumer's value-cost propositions. Commerce driven through explicit value-cost propositions can be effected within an intent-compensation user price incentive scheme, wherein compensation is issued through advertisement in response to consumer's conveyed intent, which includes value-cost propositions, in engaging in a commercial transaction with a service platform.

### TECHNICAL FIELD

The subject specification relates generally to commerce and advertisement and. more particularly, to system and methods to drive commercial transactions and advertisement based on consumer's value-cost propositions.

### BACKGROUND

In conventional customer-service provider interaction, a customer or agent selects a service or goods provider based on an expectation that the provider would deliver relevant and competent service which would satisfy the needs of the agent. In addition, cost-benefit analysis generally contributes to the selection process, with the agent seeking the most value among available alternative while alleviating costs. Once a selection is made—either a service provider is engaged in a commercial transaction, or a product is bought from a merchant—the agent conveys intent in accessing the service or utilizing a product. In response to the provided intent, an adequate selection of service provider or product generally leads to service or product satisfaction.

In such a commercial paradigm, service providers and merchants typically compete for customer's intent by offering quality service and products while campaigning for brand recognition, awareness and loyalty, as well as service or product differentiation. Merchants and service providers also aim at maximizing cost-profit based on predetermined business plans and current market conditions; advertising campaigns are typically geared accordingly.

In conventional systems, it should be appreciated that cost-value in the customer constituent of a commerce system is established independently from cost-profit in the merchant constituent in the commerce system. A commercial transaction takes place when the consumer's value and cost balance out the merchant's cost and profit on the merchant constituent.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject innovation provides system(s) and method(s) to drive commercial transactions and advertisement based on explicit consumers' value-cost propositions. Value-cost propositions express consumer's desires with respect to parameters related to a commercial transaction—product price point, sensitivity to price and time, preferred shipping mechanism(s), contractor reputation, supply chain utilized by contractor, and so on. A component registers consumers to submit their value-cost propositions and aggregates the information so conveyed to generate a market latent demand. The latter is conveyed to a set of advertisers, which include merchants and service providers, who respond to the latent demand by (i) adjusting their cost-profit propositions or (ii) countering the consumer's value-cost propositions. Commerce driven through explicit value-cost propositions can be implemented within an intent-compensation user price incentive scheme, wherein compensation is issued through advertisement in response to consumer's conveyed intent, which includes value-cost propositions, in engaging in a commercial transaction with a service platform.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF THE DRAWINGS

FIG. 1 illustrates a block diagram of an example system that drives commerce and advertisement through an agent's explicit value-cost proposition in accordance with aspects described in the subject specification.

FIG. 2 illustrates a block diagram of an example advertisement management component that facilitates advertisement delivery in response to a received value-cost proposition(s).

FIGS. 3A and 3B illustrate, respectively, an example intelligent component that facilitates determining latent demand and a privacy component that regulates the scope of information collected from an agent in accordance with aspects described in the subject specification.

FIG. 4 illustrates a block diagram of an example system that compensates an agent through ad spend in exchange for the agent's intent in accordance with aspects disclosed in the subject specification.

FIG. 5 is a block diagram of an example advertisement management component that facilitates ad spend management and advertisement delivery according to aspects described herein.

FIG. 6 illustrates a block diagram of an example system that employs ad spend to compensate an agent in exchange of the agent's intent in engaging in a transaction with a service platform in accordance with aspects disclosed herein.

FIG. 7 illustrates a flowchart of an example method for driving advertisement through an agent's explicit value-cost proposition according to aspects described in the subject specification.

FIG. 8 presents a flowchart of an example method for providing advertisers with market latent demand according to aspects set forth in the subject specification.

FIG. 9 presents a flowchart of an example method for generating an advertiser response to an agent's explicit value-cost proposition in accordance with aspects described herein.

FIG. 10 presents a flowchart of an example method for aggregating commercial information in accordance with aspects of the subject innovation.

FIG. 11 presents a flowchart of an example method for compensating an agent through advertisement in exchange of agent's intent in transacting (e.g., performing an action) with a service platform in accordance with aspects described herein.

FIG. 12 presents a flowchart of an example method for presenting advertisement to an agent and funding compensation of the agent in return for the agent's intent in accordance with aspects of the subject innovation.

FIGS. 13 and 14 illustrate computing environments for carrying out various aspects described in the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Further, the terms “component,” “system,” “module,” “interface,” “platform,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As employed herein, the terms “agent,” “user,” “customer,” “player,” “participant” and the like generally refer to a human entity (e.g., a single person or group of people) that utilizes a software application (e.g., plays, participates in, or employs a computer-implemented game; or utilizes a utility software application like presentation-preparation software, data-analysis software, online investment and related business transactions, navigation software; and so on) and possesses access to computer-related communication infrastructure, computer-related systems, electronic devices, portable or otherwise, or any combination thereof. The aforementioned terms can be, and often are, hereinafter employed interchangeably.

Furthermore, the term “service” can refer to executing a software, such as using a toolbar or web-based email engine or search engine; retrieving information (e.g., status of a pending patent application, a proposal submission, immigration process, or package delivery); purchasing goods; making a payment (e.g. mortgage, rent, student loan, credit card, car, phone, utilities, late fees); taking a class at an online school; making an appointment with an offline provider (e.g., dentist, medical doctor, lawyer, hairdresser, mechanic); or registering for an online or offline conference. It should be appreciated that this listing of services is provided as a non-limiting illustration, as other services know to one of ordinary skill are within the scope of the subject innovation.

The term “intelligence” has two meanings: (i) it refers to information that characterizes history or behavior of a person or an entity, and to records of commercial and non-commercial activities involving a product or service, or a combination thereof, of the person or entity; and (ii) it refers to the ability to reason or draw conclusions about, e.g., infer, the current or future state of a system or behavior of a user based on existing information about the system or user. Artificial intelligence (AI) can be employed to identify a specific context or action, or generate a probability distribution of specific states of a system or behavior of a user without human intervention. Artificial intelligence relies on applying advanced mathematical algorithms—e.g., decision trees, neural networks, regression analysis, cluster analysis, genetic algorithm, and reinforced learning—to a set of available data (information) on the system or user.

The subject innovation describes system(s) and method(s) to drive commercial transactions and advertisement based on explicit consumers' value-cost propositions. Value-cost propositions express consumer's desires with respect to parameters related to a commercial transaction—product price point, sensitivity to price and time, preferred shipping mechanism(s), contractor reputation, supply chain utilized by contractor, and so on. A component registers consumers to submit their value-cost propositions and aggregates the information so conveyed to generate a market latent demand. The latter is conveyed to a set of advertisers, which include merchants and service providers, who respond to the latent demand by (i) adjusting their cost-profit propositions or (ii) countering the consumer's value-cost propositions. Commerce driven through explicit value-cost propositions can be implemented within an intent-compensation user price incentive scheme, wherein compensation is issued through advertisement in response to consumer's conveyed intent, which includes value-cost propositions, in engaging in a commercial transaction with a service platform. The foregoing is described in greater detail below.

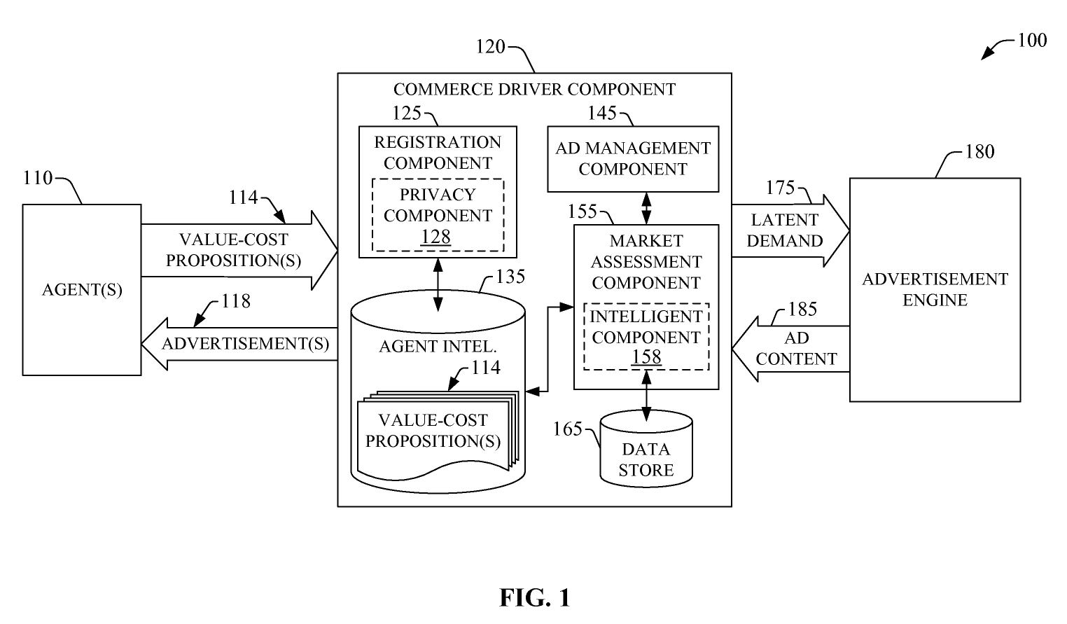

FIG. 1 illustrates a block diagram of an example system 100 that drives commerce and advertisement through an agent's explicit value-cost proposition. In system 100, agent(s) 110 conveys value-cost proposition(s) 114 related to potential commercial transactions and receives associated advertisement(s) 118. Value-cost proposition(s) 114 explicitly expresses agent(s) 110 desires or “need to have,” and “nice to have” as well, features or characteristics with respect to parameters related to a commercial transaction; for example, product price point, agent's sensitivity to price and time, preferred shipping mechanism, and so on. In addition, value-proposition(s) 114 can also be utilized to establish preference associated with services (e.g., translation services, legal services, roofing services, gardening services, solar panel installation services . . . ) instead of products; for instance, value-cost proposition(s) 114 can present desired years of experience of a contractor, materials utilized by the contractor, suppliers utilized by the contractor, contractor's reputation, and so on. It should be appreciated that value-cost proposition(s) 114 is a form of explicit, richly annotated, intent in engaging commercially with a merchant or service provider.

Value-cost proposition(s) 114 is generally conveyed to a commerce driver component 120 which can be a stand-alone component, as illustrated in embodiment 100, or it can be a part of a service platform. To convey explicit value-cost proposition(s) 114, agent(s) 110 registers with commerce driver component 120. Registration occurs via a registration component 125, which includes a privacy component 128 to ensure privacy integrity of an agent's information provided during registration process as well as in each interaction with commerce driver component 120. In an aspect, privacy component 266 maintains an agent's privacy according to privacy settings established by the agent. Privacy component 266 also manages how records of collected agent's actions are stored within an agent intelligence store 269. Functionality of privacy component is discussed in greater detail below.

Value-cost proposition(s) 114, registration information, and substantially all information traffic associated with commerce driver component 120, can be received through a communication link (not shown) which can be substantially any type of communication link, either wired (e.g., a T-carrier like T1 phone line, an E-carrier such as an E1 phone line, a T1/E1 carrier, a T1/E1/J1 carrier, a twisted-pair link, an optical fiber, and so on) or wireless (e.g., Ultra-mobile Broadband (UMB), Long Term Evolution (LTE), Wireless Fidelity (Wi-Fi), Wireless Interoperability for Microwave Access (WiMAX), etc.), or any combination thereof. In addition, information 255 can be intrinsic, e.g., conveyed by agent 110, or extrinsic, wherein intent processing component 135 collects information associated with agent 110 actions with respect to a service platform.

Collected information associated with agent's actions that are compatible with privacy regulations, or policies, is stored as agent intelligence in memory 135, which also stores received value-cost proposition(s) 114. Stored value-cost proposition(s) 114 can be aggregated and analyzed by a market assessment component 155 to generate a market latent demand 175 for products or services. It should be noted that value-proposition(s) 114 also carry commercial value individually. It is to be appreciated that latent market demand 175 is adopted as a representative of agent(s) 110 behavior but also the behavior or agents that do not provide service commerce driver component 120 with value-cost proposition(s). Market latent demand 175 can be conveyed to an advertisement engine 180 which typically responds by providing content 185 that aims at satisfying such latent demand, or matching agent(s) 110 value-cost proposition(s) 114. When compared to conventional commerce systems, at least one advantage of commerce driver component 120 is that it makes known to merchants and service providers a set of explicit value-cost propositions 114 from agent(s); thereby merchants and service providers can respond by (i) adjusting, their cost-profit propositions in order to meet latent demand 175, or (ii) countering the value-cost proposition(s) 114 by presenting alternative products or services that meet a portion of the known latent demand or meet latent demand in full subject to a restriction that a specific volume of merchandise is negotiated with a specific number of agent(s); e.g., a specific price point is offered by a merchant only when M (a positive integer) consumers purchase K (a positive integer) units of a product. It is to be noted that latent demand 175 has monetary value for merchants, service providers, and advertisers, since it provides with strategic planning information that reflects an actual market condition, from a representative cross-section of consumers, which can be segmented in various manners, if so desired, during the aggregation process.

To generate a latent demand 175, market assessment component can utilize by intelligent component 158. Through available agent intelligence 135 and value-cost proposition(s) 114, intelligent component 158 can model current market conditions, can infer future market conditions, and agent(s) 110 response to specific advertisement campaigns 118, and so on. Analysis and feature or pattern mining of information can be implemented by intelligent component to support inferences and extract desired information. In addition, intelligent component 158 can utilize supplemental data in memory 165 that can facilitate determination of latent demand 175, and interpretation of agent's value-cost proposition(s) 114. Supplemental data can include data from measurements(s) and simulation(s) of behavior, demographic influences on behavior and associated intent (e.g., agents with disparate backgrounds may convey a same intent through disparate actions), etc. Moreover, supplemental data can include data generated by intelligent component 158 in prior instances of value-cost proposition(s) 114 collection and market assessment(s). It is to be noted that based at least in part on agent intelligence 135 and supplemental data 165 as described above, market assessment component 155 (via intelligent component 158 for example) can evaluate how effective is the aggregated data arising from addition of discrete items to value-cost proposition(s) 114 at predicting future demand and commercialization, e.g., sales, of a specific product or service.

In an aspect, advertisement engine 180 can be a part of a merchant which utilizes commerce driver component to enhance business performance or to enter into a new market, or to sustain market share by mitigating customer attrition. In addition, such merchant can utilize commerce driver component as a highly-optimize, high-quality targeted advertisement service or broker. In another aspect, advertisement engine 180 can be an advertisement intermediary between a service platform (not shown) and a set of disparate merchants. In yet another aspect, advertisement engine 180 can be an integral part of, and managed by, service platform 150.

Interaction of advertisement engine 180 with commerce driver component 120 is effected through ad management component 145, which provides multiple functionalities that merchants, service providers and advertisers can utilize to respond to a received latent demand 175, or a specific value-cost proposition 114. In aspect, advertisement management component 145 can facilitate one-touch addition of advertised items to an agent's value-cost proposition(s) 114. It is to be noted that the term “one-touch” refers herein to at least one of a single click on a web-based advertisement, a single tap on a touch screen, a single aural expression, or command, on a sound (e.g., voice) responsive system, a single biometric snapshot such as a fingerprint, iris or face capture, and so on. An illustrative embodiment of an ad management component 145 is described in greater detail next.

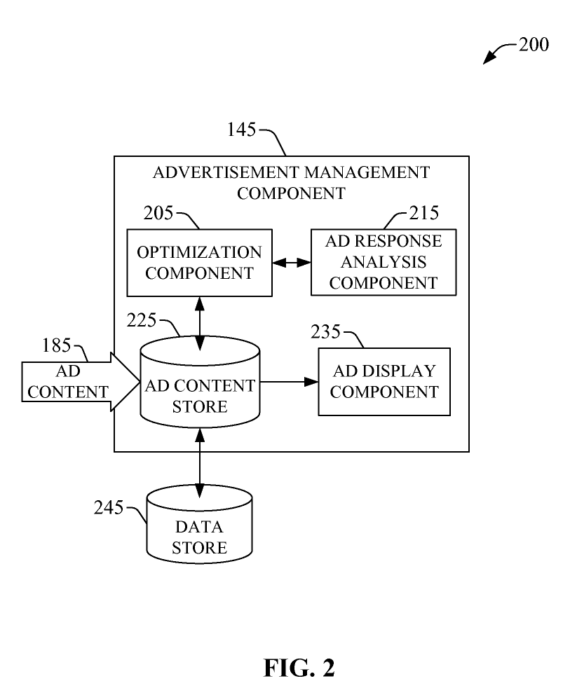

FIG. 2 illustrates an example embodiment 200 of an advertisement management component 145 that facilitates advertisement delivery in response to a received value-cost proposition(s) 114. In embodiment 200, an optimization component 205 can rely on input provided by ad response analysis component 215 to optimize advertisement format and delivery in response to received value-cost proposition(s) 114, or determined latent demand 175. It is to be appreciated that format and delivery can include, audiovisual indicia (e.g., colors, images, language, sounds, songs, public figures, patriotic icons, . . . ), density of content, frequency of ad impressions, time of ad presentation (e.g., morning, afternoon, evening, etc.), device onto which an advertisement is delivered, etc. Ad response analysis component 215 can monitor response metrics for agent(s) 110 when presented with a specific type of advertisement as a result of received value-cost proposition(s) 114, e.g., advertisement that presents item on a value-cost proposition profile, and determined latent demand 175. In an aspect, ad response analysis component can assess influence (e.g., click-through rate in advertisements) of value-cost proposition(s) 114 on advertisement(s) as a function of time (e.g., a day, a week, a month, or substantially any time scale); such information an facilitate establishing a time profile of market latent, popular items residing in value-cost proposition(s) 114, etc.

It is to be appreciated that optimization component 205 also can autonomously generate new advertisement content leveraging off existing content in ad content store 225—which is at least in part supplied with ad content 185 received from advertisement engine 180—and extrinsic data in data store 245. Generation of new ad content can be driven by analysis provided by ad response analysis component 215. In an aspect, generation of digital ad content can exploit metadata adaptation of existing content or edition (e.g., addition of a soundtrack, icons, images, etc.) of such content.

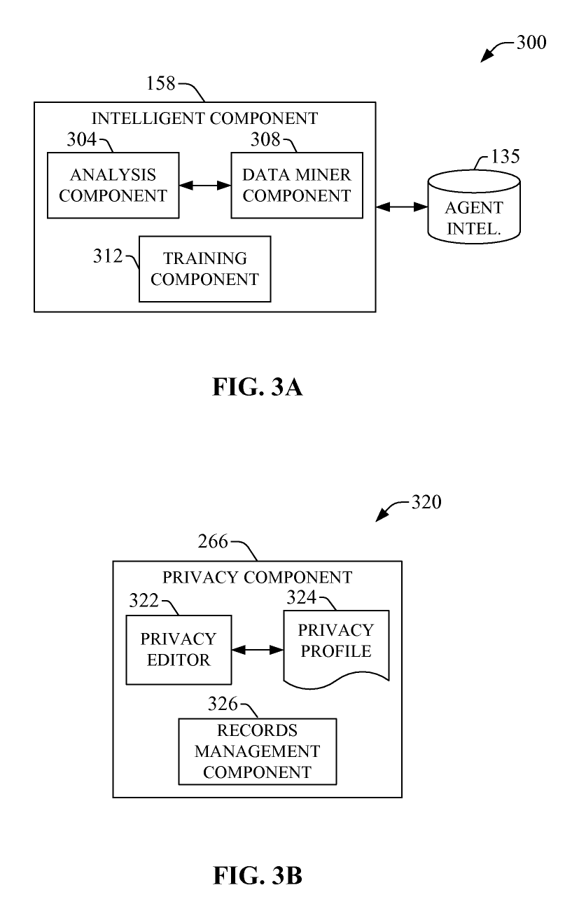

FIG. 3A illustrates an example intelligent component 272 that can reason or draw conclusions about agent's value-cost proposition(s) 114 and market conditions, in particular latent demand for product(s) or service(s) based at least in part on agent intelligence (e.g., agent's information in storage 135) and supplemental data 165 (for example, agent's internet browsing history, communication threads like email, instant messages, short message service communication) available (as permitted by privacy component 128) to commerce driver component 120. Intelligent component 158 can generate a probability distribution of specific states of agent's value-cost proposition(s) 114 without human intervention. To infer an agent's value-cost proposition, intelligent component 158 relies on artificial intelligence techniques, which apply advanced mathematical algorithms—e.g., decision trees, neural networks, regression analysis, principal component analysis (PCA) for feature and pattern extraction, cluster analysis, genetic algorithm, and reinforced learning—to a set of available (as it can be determined by privacy component 128) information associated with agent(s) 110.

In particular, the intelligent component 158 can employ one of numerous methodologies for learning from data and then drawing inferences from the models so constructed, e.g., Hidden Markov Models (HMMs) and related prototypical dependency models, more general probabilistic graphical models, such as Dempster-Shafer networks and Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. The foregoing methods can be applied to analysis of aggregated value-cost proposition(s) 114 to extract latent demand and its predictive power of future commercial engagement (e.g., sales) among merchants and service providers, consumer(s) patterns, areas of development in disparate market segments, consumer response to advertisement and other commercial stimuli, and so forth.

Analysis component 304 can execute at least a portion of the algorithms cited above for inferring an agent's value-cost proposition(s) 114, and conducting market assessment and simulation to determine a latent demand 175. In addition, additional algorithms and computational resources can reside in analysis component 304, such as Monte Carlo simulations, game theoretic models (game trees, game matrices, pure and mixed strategies, utility algorithms, Nash equilibria, evolutionary game theory, etc.) of market, or a set of agent(s) 110, behavior, and so on. Data miner 308 can further support analysis of information through data segmentation, model development for agent's behavior simulation(s) and related model evaluation (s). Training component 312 can utilize available information (e.g., agent intelligence 135, supplemental data 165) for machine learning directed to performing the above mentioned inferences.

FIG. 3B illustrates an example privacy component 266 that can be a part of a registration component 125. Privacy component 266 can comprise a privacy editor 322 which facilitates establishing a privacy profile 324. Privacy editor 322 can exploit a graphical user interface (not shown) to facilitate an agent (e.g., agent 110) to opt for a predetermined level of privacy with respect to the information that can be collected in connection with the agent's actions with respect to registration information and extrinsic information such as web browsing habits, network-based communications (e.g., web-based communication, internet-protocol telephone communications). It is to be appreciated that privacy editor 322 can be provided through a webpage maintained by commerce driver component 120 or via the advertisement engine 180, or via a third-party service platform. It should be appreciated that privacy editor 322 can be accessed asynchronously and as often as agent(s) 110 desires. In addition, agent 110 can be prompted to update his or her privacy profile 324 prior to information associated with the agent being collected. Privacy profile 324 can be encrypted to further ensure privacy integrity. It should be appreciated that an agent(s) 110 can categorize, or segment, its privacy settings in order to establish the information that can be collected in different instances or regarding disparate advertiser, merchants or service providers that transact with commerce driver component 120. Accordingly, agent(s) 110 can allow disparate advertisers, merchants, or service providers, different degrees of information collection.

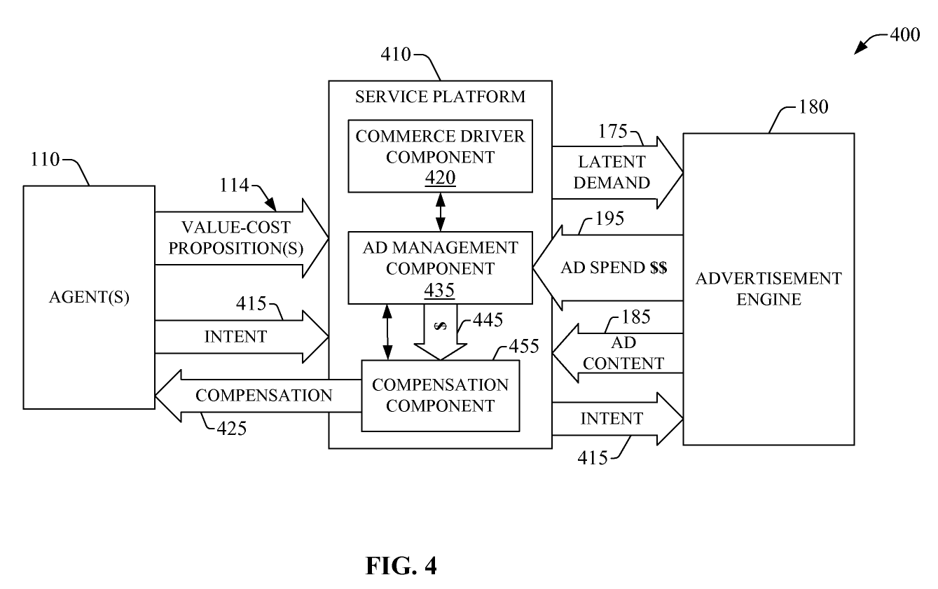

FIG. 4 illustrates an example system that compensates an agent through ad spend in exchange for the agent's intent in accordance with aspects disclosed in the subject specification. In example system 400, agent(s) 110 conveys a commercial intent 415 to a service platform 410, which compensates agent(s) 110, via compensation 425, in return for the agent's conveyed intent 415. In addition, agent(s) 110 conveys value-cost proposition(s) 114. In an aspect, value-cost proposition(s) 415 can be a portion of intent 415, wherein intent 415 can be construed as instantaneous intent and the value-proposition portion thereof as a time integrated intent. In another aspect, service platform 410 can also compensate agent(s) 110 which maintain regularly updated value-cost proposition(s) 114. It is to be appreciated that the commercial nature of agent's intent 415, and also value-cost proposition(s) 114, lies in the fact that the intent 415 as well as value-cost proposition(s) 114 reveal the underlying purpose (e.g., purchasing a merchandise, selecting or subscribing to a service or product, utilizing a software application, requesting/accessing for specialized advise, and so on) of accessing service platform 120 and constitutes a key to receiving service from it—Agent(s) 110 discloses intent 415, and value-cost proposition(s) 114, based on an expectation that the service platform 410 may be relevant to the agent's needs. By effecting such compensation, service platform 410 creates a monetary differential in favor of the customer, e.g., a user price incentive, and can distinguish itself from competitors. Such a distinction can occur at different levels: brand recognition, service/product demand, engagement of early adopters, potential for formation of business partnerships, and so on.

Service platform 410 is neither limited to a specific industry nor a specific service. Additionally, industry or service is neither limited services consumed online (e.g., through the Internet) nor offline (e.g., access to the service does not hinges on access to the Internet). A desirable characteristic of a service, or product obtained through service platform, is that the service is primarily accessed regularly (e.g., on a daily basis). Intent 415, which can include value-cost proposition(s) 114, and the service provided, or goods delivered, by service platform 410 typically are interdependent. Online service platform.—In an aspect, service platform 410 can be an online search engine, wherein the search query embodies the agent's intent in receiving a list of search results. Moreover, customer intent 415 can be related to searching for a provider or particular goods or services, and a plurality of providers may compete for knowledge of such intent (e.g., by offering rewards/incentives) in order to be presented to the customer in a favorable forum/light that will facilitate a commercial transaction transpiring between the customer and the service or product provider. In another aspect, service platform 410 can be an online portal of a technical journal, where an agent looking to retrieve a specific article provides a citation to the article (e.g., intent 415) and the publisher responds by presenting or delivering the article to the user. In another aspect, service platform 410 can be an online software application service wherein an interface customized for an agent provides the functionalities of a specific software application (e.g., payroll and benefits applications; business development and program management applications, simulation applications; online gaming applications; and so on) for a service fee. In yet another embodiment, service platform 410 can be social networking website, wherein the service platform facilitates (i) customer expression through deployment and maintenance service(s) of a webpage, and (ii) interactions among disparate customers. It should be appreciated that various additional online services can be contemplated.

Offline service platform.—Substantially any merchant or service provider that operates offline can adopt the intent-compensation paradigm described herein; for instance, car and motorcycle dealers, department stores, coffee shops, liquor stores, bookstores, and so on.

Agent(s) 110 can utilize various devices (not shown) which can either be wired or wireless (e.g., a cell phone, a laptop, tethered computer, vehicular navigation device, game console, or personal digital assistant) and with a display area that can be accessed interactively or otherwise, to convey intent 415, and/or value-cost proposition(s) 114. Based at least on disclosed information, the conveyed agent's intent 415 can be classified in at least two broad categories: (a) explicit expression of intent, and (b) implicit expression of intent. To convey intent and participate in the intent-compensation commercial scheme established in example system 400, an agent registers with system platform 410 through commerce driver component 420, which gathers agent intelligence during the registration process. In addition, the agent also can register a set of devices; registration of devices facilitates delivery of compensation and customized information related therewith such as advertisement, compensation opportunities, merchants affiliated with service platform 410 that participate in the intent-compensation commercial model, and so on. In addition to the benefits for the user in connection with participating in the intent-compensation price incentive model of service platform 410, registration with service platform 410 is also advantageous as agent intelligence can be collected at the time of registration, and utilized by service platform 120, for example, for targeted marketing campaigns.

Service platform 410 can gather intent 415 through a variety of instruments or mechanisms (e.g., portals, pop-up windows, queries, statements, utterances, inferences, extrinsic evidence, historical data, machine learning systems, webcams, charge-coupled device (CCD) cameras, microphones, feature harvesting systems, and so forth). Service platform can also evaluate the veracity of intent 415 and generate confidence metrics associated therewith. Such confidence metrics can be factored in connection with allocation of compensation 425. It should be appreciated that, unlike conventional couponing and rebate schemes, service platform 410 can determine or infers customer intent dynamically (for example via Internet or wireless communications—e.g., search engines and cellular telephones are examples of platforms suitable to deploy various embodiments described herein), and utilizes the determined intent 415 to facilitate joining the agent with advertisers and, alternatively or additionally, suitable service providers (not shown) affiliated with service platform 410 in connection with maximizing utility to the user or the service provider. In addition, service platform 410 receives value-cost proposition(s) via commerce driver component 420 substantially in the same manner as discussed above in connection with FIG. 1. It should be appreciated however, that in embodiment 400, commerce driver component 420 does not host advertisement management component 435. As discussed above, value-cost proposition(s) facilitate aggregating information and creating a latent demand 175 which is conveyed to advertisement engine 180. Service platform 410 provides agent(s) 110 with bargaining power through solicitation of intent information (the solicitation can occur through a wireless, wired, or hybrid communication link; not shown) which conventionally was often provided for free by an agent (e.g., agent(s) 110). As a result, agents can increase buying power or wealth through leveraging off the value of their respective intent information. Furthermore, a filtering process can be achieved where unmotivated service providers or merchants, or respective advertiser, are not exposed to the agents thereby mitigating spam-like solicitations. An embodiment for intent processing component is discussed below.

In an aspect, compensation 425 can be provided through advertisement; e.g., ad spend 195 and ad content 185 generated by advertisement engine 180. System platform 410 includes an advertisement management component 435 that utilizes a known (through explicit intent expression) or established (e.g., extracted from an implicit expression) agent's intent 415 to generate advertisement impressions that carry a compensation in exchange of the customer intent. Compensation can be accessed through advertisement in multiple manners, or advertisement models to unlock and/or deliver compensation: (1) Advertisement exposure. In this scenario, the advertisement impression is conveyed to the user in the form of direct compensation, wherein the advertisement is a “conduit” for delivering the compensation. (2) Advertisement instantiation. A compensation is received by instantiating the advertisement impression; e.g., by following instructions in the advertisement such as for example, responding to an online or telephonic survey; visiting an online webpage or an offline showroom, watching a movie trailer or portion of a movie soundtrack, and so on. (3) Advertisement-driven action. Compensation is the result of a specific commercial transaction between the agent that conveys intent and the advertiser. It is to be appreciated that intent-driven advertisement is intrinsically targeted, thus the likelihood of an agent engaging in a transaction with the advertiser or service platform is substantially high. In addition, for an agent that maintains a value-cost proposition profile 114, advertisement targeting is further refined. The likelihood of an agent take action can be biased via the level of provided compensation; namely, advertisement management component 435 can present advertisement that offers a compensation that is above a known or inferred engagement threshold associated with the agent that conveys the intent 415; knowledge of said threshold is largely facilitated by value-cost proposition profiles. It is to be noted that since this model to unlock compensation entails an action from an agent, it provides an opportunity to gather agent intelligent with respect to the type of commercial transaction that is enacted; namely, intelligence can include an indication (e.g., an email or voice message sent to service platform 410 and stored in data store 245 or other memory available in system 400, or substantially any other type of message) whether the advertisement-driven action is connected to an item in the agent's value-cost proposition(s), for items in a value-cost proposition profile, the time elapsed since inception in such profile until advertisement-driven action is taken, an indication that measures influence on ad-driven action of advertisement presenting item associated concomitantly to intent and agent's value-cost proposition profile, various responses of agent to ad-driven action advertisement including those advertisement that directly related to items in a value-cost proposition profile and those that do not; and so on. In an aspect, this mode to access or unlock compensation can supplement (1) or (2).

To finance compensation (e.g., compensation 425) to a customer (e.g., agent(s) 110) in exchange for the customer's intent (e.g., intent 415), service platform 410, through ad management component 435, can direct funding 445 arising from advertisement spend 195 to a compensation component 455. The amount of funding 445 directed towards compensation is typically determined according to a financial model that ensures a zero-sum scenario with respect to (a) ad spend directed towards compensation, (b) ad spend for advertising, and (c) credit awarded for advertising to advertisement engine 180 by service platform 410 over an advertisement cycle (e.g., a week, a month, a quarter, . . . ). It is to be noted that (c) can be viewed as funds that “prime the pump” for an advertisement engine 180, by providing subsidies for advertisement campaigns in emerging markets; focused on new products or services; or based on new advertising techniques, resources and media.

Once an advertisement model for compensation delivery is selected; based at least in part on the nature—explicit or implicit expression—of the intent 415 received by service platform 410 and available value-cost proposition(s) 114, the available intelligence on the originating agent, etc.; and consistent action has been taken by a customer (e.g., agent(s) 110), compensation component 455 delivers compensation 425. To that end, compensation component 455 performs multiple tasks, which comprise accounting, managing fraud mitigation, and retaining records associated with compensation. In an aspect, compensation component 455 can manage issued compensation like adopting changes to face-value of compensation 425; for instance, conferring a promotional value, typically above average or generally awarded value, to the compensation 425 if specific actions are taken by an agent like responding to an online product survey or visiting an offline store show-room within a specific period of time. In another aspect, compensation component 455 can determine specific compensation according to agent intelligence available to service platform 410, in order to mitigate customer attrition, or increase the quality of information associated with intent (e.g., increase the instances in which intent is conveyed via explicit rather than implicit expression). In yet another aspect, compensation component 455 can broker partnerships with disparate online or offline merchants that may be affiliated with service platform 410.

It is to be appreciated that through a set of registered mobile devices, compensation component 455 can provide compensation either online or offline. Registration of devices that can receive compensation facilitates the optimization of a device's resources when conveying an advertisement that carries compensation. Furthermore, a set of devices that are utilized at the time an eligible action is undertaken by agent 110 can drive the compensation type. For example, agent(s) 110 utilizes an online service to trade stocks (a possible embodiment of service platform 410) in a laptop computer while agent(s) 110 listens to music in a Zune® digital media player—that agent(s) 110 is listening music in a Zune® device can be gleaned from information collected by webcam operating on the agent's laptop computer and conveyed to service platform 410—at a specific instance agent(s) 110 buys stock from an entertainment company. The system platform, based on the transaction, available intelligence about the user, and the fact that the user is listening to a Zune® device, result in a digital song delivered to the user email inbox (and possibly a notification to the agent's cell phone) as a compensation for conveying intent to the stock trading system. The illustrative scenario described hereinbefore displays a central advantage of the intent-compensation price incentive scheme herein disclosed with respect to conventional system: Compensation can be synergistically customized based on context and behavior, rather than established solely on user intelligence or eligible action.

As illustrated above, compensation 425 has monetary value. Monetary value can be effected (i) directly, e.g., monies are deposited in a compensation account (not shown in FIG. 4) that belongs to agent(s) 110, or debt carried by agent(s) 110 in, for example, credit card(s) is reduced by a specific amount—it should be appreciated that such credit card(s) can be issued or managed by service platform 410 or an affiliated lender (e.g., service provider) which makes debt reduction substantially more affordable and advantageous to the service platform 410. Direct payments can be electronic and effected in real time, via a wireless transmission directly to a debit/credit card registered by agent(s) 110. The magnitude of a direct payment awarded to agent(s) 110, as compensation 425, is generally a function of multiple variables: enrollment longevity, income bracket, educational level, professional activities, leisure activities, and demographics factors. Based at least in part on such parameters, compensation component 455 can determine an adequate compensation for agent(s) 110. It is to be appreciated that agent 110 can be notified to one or more of the agent's registered devices that a direct payment incentive has been awarded; for example, in an online interaction a user can receive an instant message describing the type and magnitude of the compensation, or in an offline interaction the user can receive a short message service (SMS) message to the agent's cell phone, pager, or any other registered device.

Monetary value can also be effected (ii) indirectly, such as through reward points, service-specific points, platform-specific points, virtual monies or points, e.g., Microsoft® Points or substantially any other denomination, that can be used to claim a rewards either online or offline. In addition, agent 110 can be compensated with generic points (or substantially any other tokens associated with materializing a compensation) that facilitate claiming products or merchandise of different types and scope. Points, generic or otherwise, can be perishable or perennial, and can be transferred to a second agent (not shown). It should be appreciated that, in an aspect, generic points can be managed dynamically by service platform 410, adopting promotional value to drive a specific product or service campaign, or changing scope as a function of the point bearer (e.g., a compensated agent like agent 410). An alternative or additional form of indirect monetary compensation can be effected through digital merchandise like songs; ring-tones; movies; pictures; books; magazine articles, technical or otherwise; greetings cards; games, console-based and online, single-player or multiplayer; software application add-ons such as Microsoft® Visio® stencils or custom font sets; foreign-language dictionaries; maps, secret passages, and answers to riddles for second worlds relevant to role playing games, and so on.

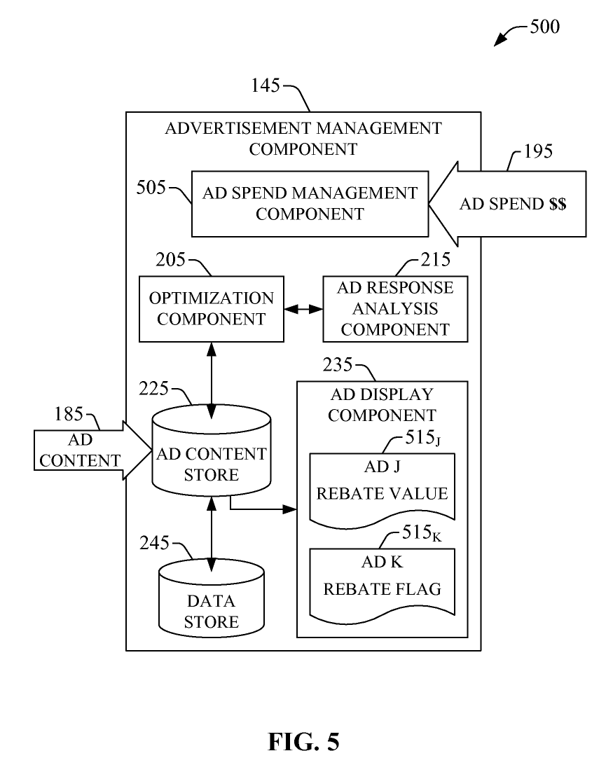

FIG. 5 illustrates an example embodiment 500 of an advertisement management component 145 that facilitates management of ad spend and delivery of advertisement. Embodiment 500 presents components common to previously discussed embodiment 200, such component are indicated with the same numeral utilized in embodiment 200 and possess the same functionality discussed above. Illustrative component 145 comprises an ad spend management component 425 that receives and manages advertisement spend 195 from advertisement engine 180. As discussed above, a portion of the received ad spend 195 is directed to compensation of an agent in exchange for the agent's intent in engaging in a transaction with service platform 120. Advertisement management component 145 also includes an optimization component 415 that (i) adjusts advertisement content delivered to an agent, and (ii) optimizes advertisement format in accordance with a registered device utilized by the agent. It is to be appreciated that optimization of advertisement format for according to the media resources of a particular device (e.g. a device with limited display real state, or a device with limited sound capabilities such as a navigation system) provides the agent with a richest advertisement experience available to the device and thus increases the likelihood that the agent responds to the advertisement.

In embodiment 500, optimization of advertisement format and delivery via optimization component 205 can rely on input provided by ad response analysis component 215 which can monitor response metrics for agent(s) 110 when presented with advertisement(s) carrying specific types of compensation 425. For example, it can be determined that an agent is more likely to effect an advertisement-driven (e.g., respond to a survey, follow a link to a beta release of a website, buy a merchandise) action when the presented advertisement contains age-appropriate music or sound indicia rather than when the advertisement is solely based on imagery. As another example, it can be measured that an agent responds more favorably to advertisement instantiation when cinema, television, or music stars appear on the delivered advertisement endorsing a product or service. For instance, typically at check out, a cashier at a supermarket issues paper coupons for specific merchants based on the purchased goods, while for a segment of customers paper coupons are useful for a disparate segment, e.g., early adopters, a soft version of the coupon can increase likelihood of coupon redemption; accordingly, in an aspect of the subject innovation, an information collection component can gather information via a set of cameras and microphones deployed at the cashier and an analysis component can identify the customer with a specific customer segment, subsequently a coupon format optimized for the customer segment is delivered; e.g., an indication to print a coupon is conveyed to the cashier or a coupon is wirelessly conveyed to customer's smart phone.

It should be appreciate that compensation, or related advertisement, adaptation based at least in part on value-cost proposition(s) 114 provides at least two advantages with respect to conventional “one format fits all” couponing systems: (a) increases likelihood of a posteriori engagement as a result of customized delivered compensation, and (b) magnitude of the coupon can be adjusted contextually in an agent-centric manner, rather than determined based on purchase-centric metrics, e.g., number of specific purchased items.

In embodiment 500, ad display component 235 can display advertisements that carry an intent-based compensation. Advertisement conveyed through ad display component 445 can be rendered at stationary offline points or on substantially any device typically utilized by agent(s) 110 and registered with service platform 410. Displayed advertisements can present a compensation flag (e.g., 515_{K}) or an exact-rebate-value (e.g., 515_{J}) flag. It is to be appreciated that rebated value can be adapted to specific characteristic of the agent to which the advertisement is presented to, such as agent's value-cost proposition(s) profile. Thus, in an aspect, an advertiser can differentiate its rebates based at least in part on item extant in a value-cost proposition profile; for instance, higher quality rebates can de presented to agents that maintain value-cost proposition(s) profile. Such differentiation offers at least the advantage of promoting agent(s) to maintain a value-cost proposition 114, with the ensuing commercial benefits for both agent 110 and service platform 410. Advertisements can be conveyed in multiple formats (e.g., image-based (e.g., banners), text-based, sound-based, or a combination thereof) depending on the media resources available to the agent's device in which the advertisement is rendered, or available to an advertisement “dock” (e.g., an outdoor electronic banner) for display of intent-compensation advertisements offline. In one embodiment, ad display component 235 can be employed to notify agent(s) 110 of advertised compensation after agent(s) 110 is no longer utilizing service platform 120. In such embodiment, ad display component 445 can communicate advertisements that were previously presented to agent(s) 110 to substantially any of the devices typically utilized by the agent(s) 110 and registered. Such embodiment adds value for the service platform and the advertiser as it increases the lock-in of the user with the service platform 410 by increasing the likelihood of repeat engagements, in which new advertisements can be presented to agent 110.

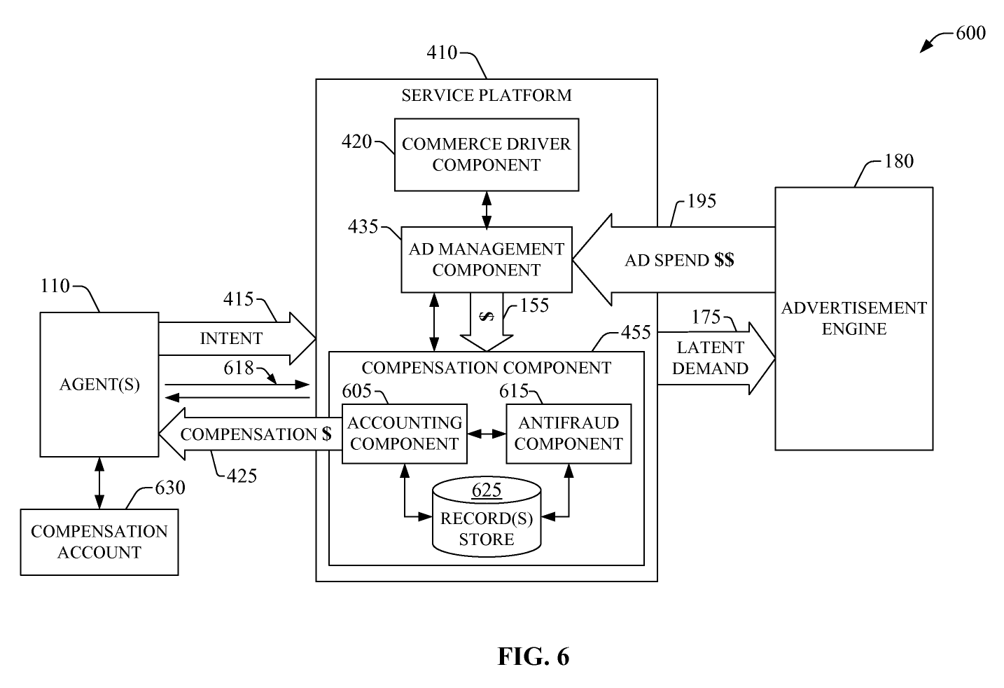

FIG. 6 illustrates a block diagram of an example system 600 that employs ad spend to compensate an agent (e.g., agent 110) in exchange of the agent's intent in engaging in a transaction with a service platform (e.g., service platform 120). As discussed above, compensation typically is effected through specific responses to advertisement events (e.g., advertisement exposure, advertisement instantiation, or advertisement-driven action like an ad-click or a purchase). Advertisement are generally adjusted according to received value-cost proposition from agent(s) 110; in an aspect, such value-cost propositions can be part of received intent 415 and are processed by commerce driver component 420 as discussed above. In addition, commerce driver component conveys latent demand 175 to advertisement engine 180, as previously discussed.

In system 600, service platform 410 receives a payment 185 to display advertisements for advertisement engine 180 in accordance with a determined agent's intent 415. In a further yet aspect, ad management component 435 processes ad spend 185, and splits it in two streams: A portion of monies 185 are retained as advertisement revenue for service platform 410 or directed toward a revenue account (not shown), and a remaining portion of monies 185 are directed towards agent compensation 125. As discussed above, compensation monies can be utilized to award an agent (e.g., agent 110) a direct payment, or can be employed to fund merchandise and products employed to compensate the agent, the merchandise and products associated with service platform 120 or disparate manufacturers or service providers (not shown) affiliated with the service platform 120. Compensation of an agent (e.g., agent 110) through a direct payment or an allocation of reward points can be delivered (via communication link 618) to a compensation account 630 that belongs to agent(s) 110.

As discussed above, compensation 425 typically has monetary value; thus, to ensure compensation is adequately awarded, accounted for, and recorded, compensation component 455 includes an accounting component 605, an antifraud component 615, and a records store 625. Accounting component 605 can account for payments, retain compensation records in record(s) store 625, and monitor a current level of compensation for the agent to ensure, for example, compensation fails to surpass a compensation limit. In an aspect, accounting component 605 can conduct the accounting of points (e.g., generic points, reward point, or platform specific points like Microsoft® Points) issued by compensation component 455 and associated with a specific compensation event. In addition, the compensation event can be recorded. Generally, compensation records can include type and amount of compensation delivered to agent(s) 110; time compensation was delivered, type of advertisement response—e.g., advertisement exposure, advertisement instantiation, or advertisement-driven action—that unlocked compensation; degree of association or correlation between intent, advertisement response that led to compensation and agent's value-cost proposition(s). Such records can augment available intelligence on agent(s) 110, stored on agent intelligence 135. Retaining records of delivered compensation and associated sources of intent and value-cost proposition(s) facilitate to resolve disputes that can arise from registered agents claiming an eligible uncompensated transaction with an advertiser. In a dispute, service platform 410 can either directly refund the agent setting forth the claim of unpaid compensation, or start an audit of the intent-based transaction to confirm its veracity.

Antifraud component 615 manages security features that mitigate fraudulent exploitation of compensation and preserve compensation records integrity. Antifraud component can exploit various resources such as agent intelligence stored, for example, in agent intelligence store 135, data stored in memory 245, intelligent component 158 and optimization component 205 (which can also rely on intelligent component 158), and so forth. Moreover, antifraud component 615 can implement detection of biometric markers (e.g., voice signature, face-feature recognition like recognition of scars, moles, freckles, eye color and iris structure, and so on) in online and offline compensation that can facilitate biometric-based verification to ensure that an intended customer indeed received an intended compensation. Antifraud component 615 can provide substantially all functionality associated with probing biometric features (e.g., cameras for bio-feature recognition, fingerprint pads, iris scanners . . . ), encrypting/decrypting online compensation, etc; yet, utilization of resources available to other system components (e.g., intent processing component 135) can also be exploited.

In addition, antifraud component 615 can ensure intent is actually conveyed by a legitimate agent, e.g., agent 110, instead of an automated script that emulates an agent. Mitigation of automated generation of counterfeit intent can be particularly relevant in realizations in which intent is conveyed online. In view of the intent-based antifraud component 615 can implement variations of Turing tests to discern whether a counterfeit agent is conveying intent 415, which can include value-cost proposition(s) 114; antifraud component can present a suspicious agent with advertisement unrelated to the submitted intent 415, and/or value-cost proposition(s) 114. In an aspect, antifraud component 615 can pose questions associated related with collected information professional and whose expected answers are inferred with a high degree of confidence and an automated source of intent is highly likely to fail answering correctly. In another aspect, antifraud component 615 can determine whether incoming intent (e.g., intent 415 or value-cost proposition(s) 114), or associated information, from specific agent(s) (e.g., agent(s) 110) obeys a specific pattern; for example, intent is conveyed, or value-cost proposition is updated, periodically, seasonally (e.g., at specific times of a day, a week, a month), and so forth.

Antifraud component 615 can mitigate fraudulent compensation by systematically reducing the face-value of delivered compensation or proposed response to a value-cost proposition 114, for reiterative intent that is determined to be likely fraudulent. A characteristic relaxation time for compensation value can be determined according the degree of confidence on the illegitimate nature of the received intent.

In instances in which compensation relies on an advertisement-driven action that allows agent(s) 110 to effect the action during a specific period of time, antifraud component 615 can generate a uniquely linked (e.g., via an N-bit (N a positive integer) key) token pair to identify agent(s) 110 and the action and an associated advertiser that requests the action. The token pair facilitates recognizing the agent once the ad-driven action is effected and delivering the ensuing compensation (e.g., compensation 425, or a discount in response to a value-cost proposition 114). It should be appreciated that compensation component can convey agent's identification via communication link 618. A record of the notification, and the associated token pair, can be retained in record(s) store 625 or in agent intelligence memory 135.

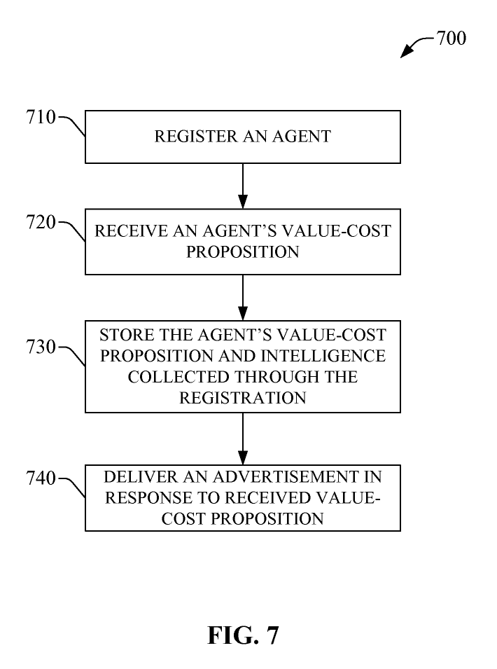

In view of the example systems, and associated aspects, presented and described above, methodologies for driving commerce and advertisement according to explicit consumer's cost-value proposition that may be implemented in accordance with the disclosed subject matter can be better appreciated with reference to the flowcharts of FIGS. 7-12. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 7 is a flowchart of an example method 700 for driving advertisement through an agent's explicit value-cost proposition. Advertisement can generally be provided by an advertisement engine coupled to a component that facilitates agent's delivery of explicit value-cost proposition(s). Advertisement can also be a portion of an intent-compensation consumer price incentive implemented through a service platform (e.g., service platform 120). Service(s) or product(s) can be delivered online or offline. Similarly, agent's intent can be conveyed online or offline, gleaned from implicit or explicit expressions or actions. At act 710, an agent is registered. Registration provides collection, according to a privacy policy, of information related to the agent. Typically registration is with a component that facilitates disclosing an agent's explicit value-cost proposition. At act 720, a value-cost proposition is received. Such a proposition is typically a an information profile that describes conditions (e.g., price points, product or service characteristics, time and price-point sensitivities, and so on) for engaging in a commercial transactions. At act 730, the agent's explicit value-cost proposition is stored along with intelligence collected through the registration process. At act 740 an advertisement is delivered in response to the received value-cost proposition.

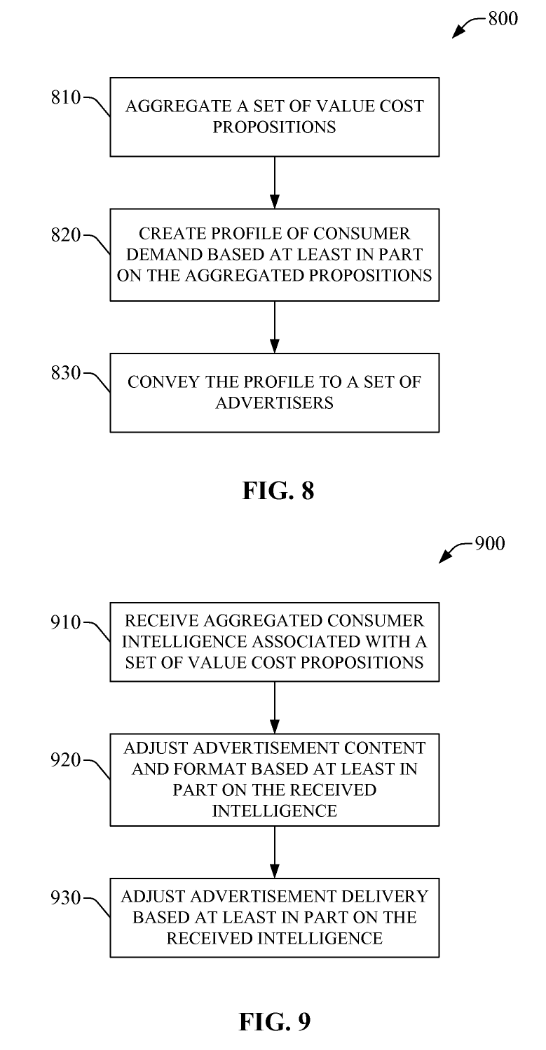

FIG. 8 presents a flowchart of a method 800 for providing advertisers with market latent demand in accordance with aspects described herein. At act 810 a set of value-cost propositions is aggregated. In an aspect, such value propositions originate from a set of N agents, with N a positive integer; however, at least a portion of such value-cost proposition(s) can be generated through simulation or inference of agent behavior or preference. Aggregation can not only reflect a latent demand, or demand, associated with a segment of a market (e.g., a universe of N users, with N a positive integer) but it can also reflect correlations among the constituents of the market segment and their commerce preferences. In view of its impact on business operations (e.g., logistics, inventory, marketing, supply-chain, . . . ) such information possess monetary value to advertisers. In an aspect, advertisers can exploit aggregated information derived from value-cost proposition(s) (e.g., value-cost proposition 114) to direct specific rebates (e.g., compensation 425) towards items (e.g., products, services, brands . . . ) actively pursued by consumers as reflected via value-cost proposition(s) in order to promote such items penetration in the market. Likewise, advertisers can mitigate market presence, or development, of specific items (e.g., products, services, brands . . . ) that fails to drive consumer activity (e.g., sales, applications for credit, and so on). At act 820, a profile of consumer latent demand is created based at least in part on the aggregated propositions. Creation of the profile, in an aspect, can proceed via simulation or inference, historic data on consumer response to advertisement (e.g., advertisement(s) 118) associated with a set of existing individual or aggregated value-cost propositions, and so on. It is to be noted that the profile of latent demand can be created as a function of time based on various aspects of consumer intelligence (e.g., agent intelligence 135) discussed herein. At act 830, the profile is conveyed to a set of advertisers. In an aspect, the conveying act is remunerated by the advertisers.

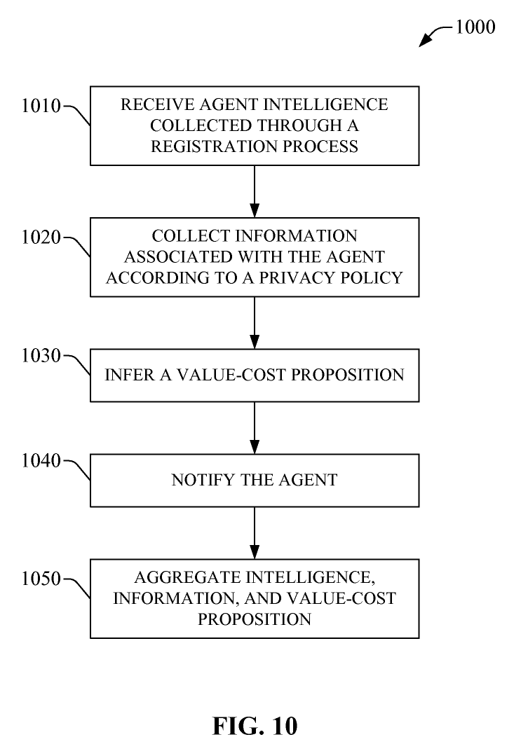

FIG. 9 presents a flowchart of an example methodology 900 for generating an advertiser response to an agent's explicit value-cost proposition. At act 910, an aggregated consumer intelligence associated with a set of value-cost propositions is received. At act 920 an advertisement content and format is adjusted based at least in part on the received aggregated consumer intelligence. At act 930 an advertisement delivery method is adjusted based at least in part on the received aggregated intelligence. In an aspect, delivery adjustments can include changes to media, to advertisement layout, to frequency and time (e.g., morning, afternoon, evening, late nigh) an advertisement content is displayed, to information density conveyed in an advertisement, and so on.

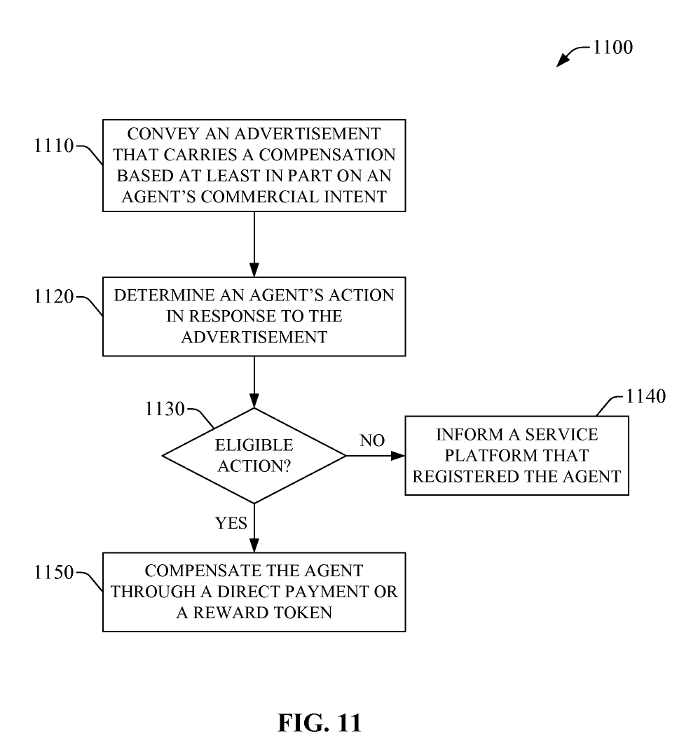

FIG. 10 is a flowchart of an example method 1000 for aggregating commercial information in accordance with aspects disclosed herein. At act 1010, agent intelligence collected through a registration process is received. At act 1020 information associated with the agent is collected subject to a privacy policy established by the agent. In aspect, the collected information is extrinsic to a commercial intent or a value-cost proposition; for instance, the information can related to internet browsing habits, to communication threads (email messages, instant messages, short message service communications, instant messages, content posted on a community board, etc.) among peers or members of a social network, or content conveyed in blog(s) maintained by the agent, and so on. At act 1030, a value-cost proposition is inferred for the agent based at least in part on the received intelligence and the collected information. At act 1040 the agent is notified that a value-cost proposition has been prepared (e.g., through inference); such notification can elicit a response from the agent, furthering commercial “stickiness” with a platform that inferred the value-cost proposition. In an aspect, the notification can be conveyed to multiple electronic devices (mobile phone, smart phone, pilot digital assistant, laptop computer, desktop computer, message boar, television, etc.) that the agent possesses and has registered with a service platform that created the value-cost proposition. At act 1050 received intelligence, collected information, and inferred value-cost proposition is aggregated.

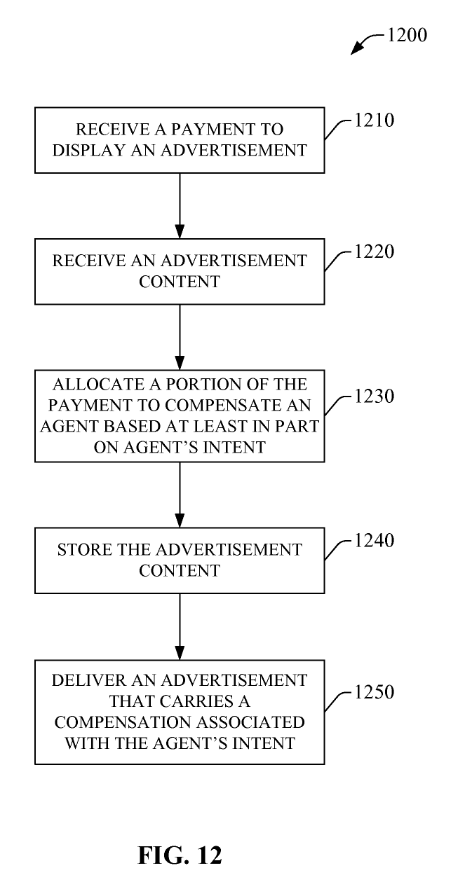

FIG. 11 presents a flowchart of an example method for compensating an agent through advertisement in exchange of agent's intent in transacting (e.g., performing an action) with a service platform like platform 120. At act 1110, an advertisement that carries compensation (e.g., Ad J 515_{J} or Ad K 515_{K}) is conveyed, wherein the compensation is based at least in part on an agent's commercial intent, a response to a value-cost proposition conveyed by the agent, or a latent market demand. In an aspect, compensation is funded through advertisement spend originated by an advertisement engine (e.g., ad engine 180). The advertisement engine can be a part of a service platform with which the agent interacts commercially, can be a conglomerate of advertisers managed by an advertisement agency that manages and maintains the advertisement engine, or it can be a portion of a content, product or service provider affiliated with the service platform. It should be appreciated that either the advertisement agency or the affiliated provider can run business operations exclusively offline or exclusively online. Alternatively, or in addition, advertisers can be associated with online business operations. It is to be appreciated that regardless the nature of the business operations in connection with the advertisement engine, an advertisement management component can administer advertisement online or offline.

At act 1120, an agent's action is determined in response to the conveyed advertisement. The advertisement can indicate the agent that an action is required in order to receive a compensation (e.g., advertisement-driven-action-to-compensation model). Alternatively, compensation can be delivered through advertisement exposure or advertisement instantiation (e.g., the agent opens a link to the advertisement, opens a message carrying the advertisement, received a call for a “sales pitch” advertisement, . . . ).

At act 1130, the action is checked in order to determine whether the agent has engaged according to the advertisement model (e.g., exposure, instantiation, action) for compensation. When the agent fails to act accordingly, a service platform that registered the agent is informed at act 1140. In an aspect, receiving such information provides the service platform to adjust or optimize advertisement content or delivery in order to promote agent lock-in with the action proposed in the advertisement. At act 1150, an agent that performs an eligible action is compensated through either a direct payment (e.g., deposit in a bank account, retirement account, college savings account, credit card account, brokerage account, college/school/childcare tuition account, and so on), or via a reward token like reward points or point currency, digital goods or content, coupons for offline or online stores, and the like.

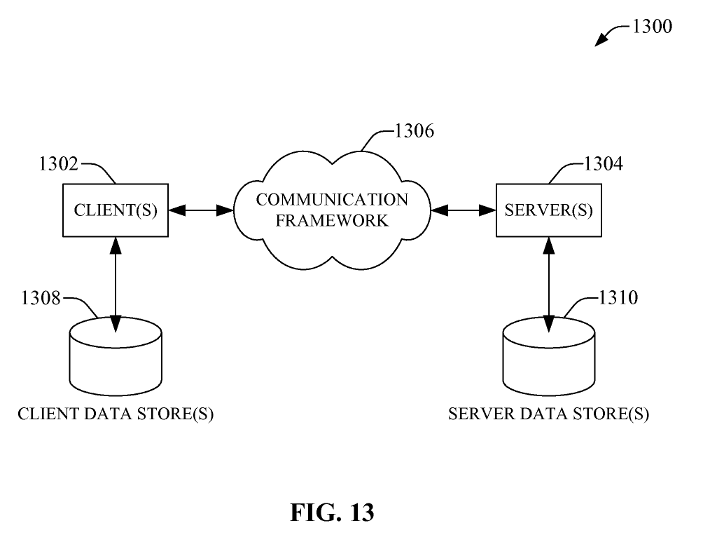

FIG. 12 presents a flowchart of an example method 1200 for presenting advertisement to an agent and funding compensation of the agent in return for the agent's intent in accordance with aspects of the subject innovation. At act 1210, a payment to display an advertisement is received. Generally, a service platform receives the payment. The service platform is not limited to operate commercially online or offline, and it can be associated with a variety of services and products; the latter can be accomplished through affiliated content (e.g., products, services) providers. At act 1020 advertisement content is received. The ad content need not be an advertisement product; instead, the content can be (1) a set of guidelines and expectations for an advertisement campaign; (2) customer intelligence, such as customer demographics and associated segmentation, research results from focus groups and polls, models and lift charts for direct messaging campaigns (e.g., direct mail, instant messaging, email), etc.; (3) elements known to be effective in locking-in target customers such as music, images, quotes, excerpt of speeches, and so on; (4) pilot, non-optimal advertisement campaigns; and so forth. At 1230, a portion of the payment is allocated to compensate an agent based at least in part on the agent's intent. At act 1240, the advertisement content is stored (e.g., in a memory component like ad content store 225). In an aspect, stored ad content can be utilized for ad campaign content and format optimization, e.g., via optimization component 205. At act 1250 an advertisement associated with the agent's intent is delivered. The advertisement can be delivered online or offline, with features optimized, or targeted, for a specific agent or for a specific device operated by the agent. Customization of advertisement can be accomplishment autonomously based on existing intelligence on the agent (e.g., information stored in agent intelligence 135).

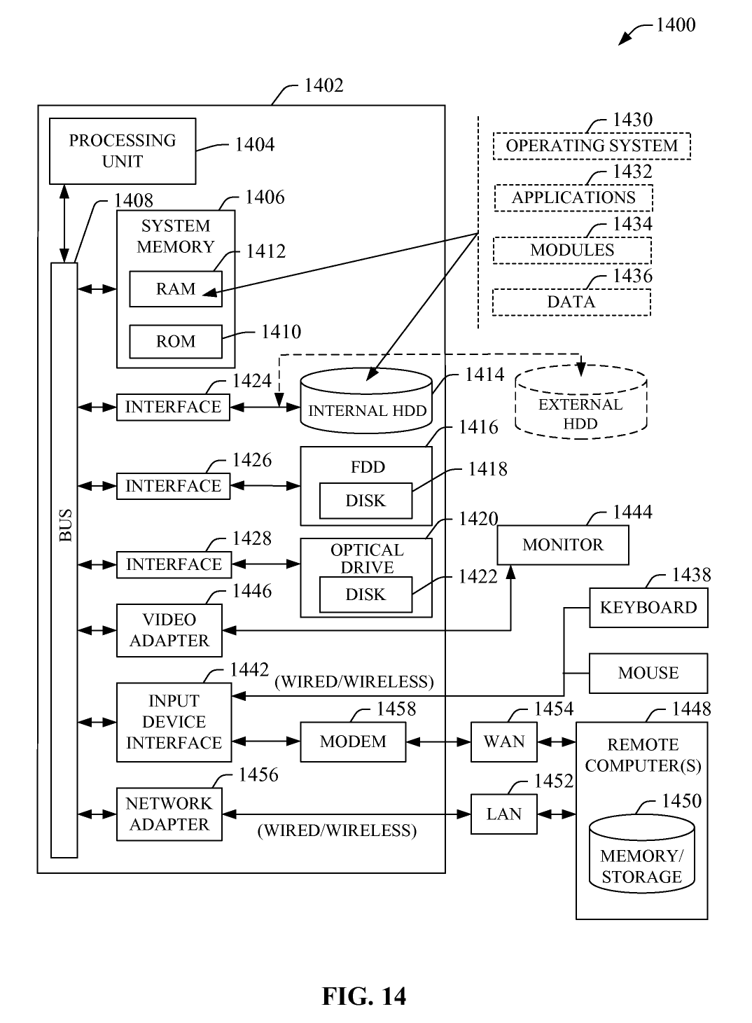

In order to provide additional context for various aspects of the subject specification, FIGS. 13 and 14 and the following discussions are intended to provide a brief, general description of suitable computing environments 1300 and 1400 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

FIG. 13 illustrates a schematic block diagram of a computing environment in accordance with the subject specification. The system 1300 includes one or more client(s) 1302. The client(s) 1302 can be hardware and/or software (e.g., threads, processes, computing devices). The client(s) 1302 can house cookie(s) and/or associated contextual information by employing the specification, for example.

The system 1200 also includes one or more server(s) 1304. The server(s) 1304 can also be hardware and/or software (e.g., threads, processes, computing devices). The servers 1304 can house threads to perform transformations by employing the specification, for example. One possible communication between a client 1302 and a server 1304 can be in the form of a data packet adapted to be transmitted between two or more computer processes. The data packet may include a cookie and/or associated contextual information, for example. The system 1200 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

In FIG. 14, the example environment 1400 for implementing various aspects of the specification includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the specification can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 408 via an interface, such as a video adapter 1446. In addition to the monitor 444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adapter 1456 may facilitate wired or wireless communication to the LAN 1452, which may also include a wireless access point disposed thereon for communicating with the wireless adapter 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are example and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the terms “includes,” “has,” “possesses,” and the like are used in either the detailed description or the claims, such term is intended to be inclusive in a manner similar to the term “comprising” as “comprising” is interpreted when employed as a transitional word in a claim.

What is claimed is:

1. A system that facilitates commerce and advertisement, the system comprising:
a component that registers a set of consumers;
a component that receives a set of value-cost propositions from the set of registered consumers;
a component that generates a consumer latent demand; and
an advertisement management component that delivers an advertisement in response to the consumer latent demand.

2. The system of claim 1, the consumer latent demand is based at least in part on aggregated value-cost propositions.

3. The system of claim 1, a value-cost proposition comprises at least one of a product price point, a sensitivity to price and time, a preferred shipping mechanism, a contractor reputation, a supply chain utilized by a contractor.

4. The system of claim 1, further comprising a storage component that stores the set of value-cost propositions.

5. The system of claim 1, further comprising a storage component that retains intelligence on a registered agent.

6. The system of claim 2, wherein the advertisement management component adds an item in a value-cost proposition through a one-touch action, wherein the one-touch action is at least one of a single click, a single tap, a single aural expression, a single biometric snapshot.

7. The system of claim 2, wherein the advertisement management component displays an advertisement in response to a received set of value-cost propositions.

8. The system of claim 4, wherein the advertisement management component includes:
an advertisement content store that retains advertisement content;
a component that optimizes an advertisement's content in accordance with the intelligence stored on the registered agent;
a component that optimizes an advertisement's format in accordance with at least one device in the set of registered devices; and
a component that analyzes a registered agent's response to an optimized advertisement.

9. The system of claim 4, further comprising an advertisement spend management component that allocates an advertisement payment towards compensation.

10. The system of claim 1, further comprising a component that compensates the registered agent via advertisement spend in return for the agent's intent, wherein the intent includes a value-cost proposition.

11. The system of claim 7, wherein a compensation is delivered through an agent's action elicited through the advertisement, the compensation customized based at least in part on a set of value-cost propositions.

12. The system of claim 9, the component that compensates the registered agent includes:
a component that accounts awarded compensation to a registered agent;
an antifraud component that mitigates fraudulent compensation; and
a component that retains compensation records.

13. A method for driving commerce and advertisement through explicit consumer value-cost proposition(s), the method comprising:
registering an agent;
receiving a value-cost proposition from the registered agent; and
delivering an advertisement in response to the received value-cost proposition.

14. The method of claim 13, a value-cost proposition comprises at least one of a product price point, a sensitivity to price and time, a preferred shipping mechanism, a contractor reputation, a supply chain utilized by a contractor.

15. The method of claim 13, further comprising:
storing the agent's value-cost proposition; and
storing agent intelligence collected through the registering act.

16. The method of claim 15, further comprising:
aggregating a set of received value-cost propositions;
creating a profile of agent latent demand based at least in part on the aggregated value-cost propositions, the profile is created as a function of time; and
conveying the profile to a set of advertisers.

17. The method of claim 16, aggregating a set of received value-cost propositions includes:
receiving agent intelligence collected through a registration process;
collecting information associated with the agent according to a privacy policy;
inferring a value-cost proposition for an agent and notifying the agent; and
aggregating the agent intelligence, the collected information on the agent, and the inferred value-cost proposition.

18. The method of claim 17, delivering an advertisement in response the received value-cost proposition includes:
receiving aggregated consumer intelligence associated with a set of value-cost propositions;
adjusting advertisement content and format based at least in part on the received intelligence; and
adjusting advertisement delivery based at least in part on the received intelligence.

19. The method of claim 15, further comprising:
receiving a payment to display the advertisement;
allocating a portion of the payment to compensate an agent based at least in part on an agent's commercial intent and a value-cost proposition; and
delivering an advertisement associated with the agent's commercial intent and value-cost proposition.

20. A computer-readable medium having code stored thereon that, when executed by a computer, cause the computer to carry out the following acts:
receiving a set of value-propositions;
storing the set of received value-cost propositions. aggregating a set of received value-cost propositions;
creating a profile of consumer latent demand based at least in part on the aggregated value-cost propositions;
conveying the profile of consumer latent demand to a set of advertisers; and
delivering an advertisement in response to the profile of consumer latent demand.
